(19) United States
(12) Patent Application Publication
(10) Pub. No.: US 2014/0066196 A1
(43) Pub. Date: Mar. 6, 2014

(54) REALTIME COLOR VISION DEFICIENCY CORRECTION

(71) Applicant: Colin William Crenshaw, Reseda, CA (US)

(72) Inventor: Colin William Crenshaw, Reseda, CA (US)

(21) Appl. No.: 13/599,867

(22) Filed: Aug. 30, 2012

(51) Int. Cl. A63F 13/00

(52) U.S. Cl. 463/31

(57) ABSTRACT

Real-time modification of pixel colors for displays, such as video game displays, may be performed to account for color vision deficiency. The modifications can be performed using operations utilizing constant matrices, with operations performed in the LMS color space. For example, a pixel may be transformed from an RGB color space to the LMS color space, a difference between a simulated color-vision deficient response and the pixel may be determined, and the difference may be distributed in the pixel such that the response is effectively taken from defective cones and distributed to functioning cones, with the resulting pixel transformed back to the RGB color space for display.

### BACKGROUND OF THE INVENTION

The present invention relates to video games, and more particularly to video game display processing to account for color-vision deficiencies.

Video games are enjoyed by many, and often allow video game players to immerse themselves in a virtual world, virtually participating in possibly otherwise unavailable activities. With high resolution displays readily available, the virtual world may authentically be displayed in a colorful, vibrant, dynamic manner.

Unfortunately, not all may be able to enjoy the colorful, vibrant displays provided by video games. Color vision deficiency, commonly known as color blindness, affects a significant percentage of the population. Those with color blindness may have a reduced ability, or even inability, to see certain colors or distinguish certain colors among similar wavelengths. Such a condition may detract from enjoyment of video game play, not only in terms of reduced appreciation of visually rich displays, but also in terms of reduced success in performing mechanics of game play, considering that many games may utilize colors to distinguish game elements or other indicia of the virtual world that may be important in game play.

Providing for a visually appealing and displayable video game displays appropriate for all may be difficult. Color blindness may have a variety of different wavelength responses. For example, congenital color blindness may take the form of Monochromacy, Dichromacy and Anomalous Trichromacy. Monochromacy, sometimes referred to as total color blindness, occurs when two or three of the cone pigments are missing resulting in the inability to distinguish colors. Anomalous Trichromacy occurs when one of the three cone pigments is impaired, for example when one of the three cone pigments is altered in its spectral sensitivity. Dichromacy occurs when one of the cone pigments is missing or not functioning. Moreover, Dichromacy may take the form of Protanopia. Deuteranopia and Tritanopia. Protanopia is a severe type of color vision deficiency caused by the complete absence of red retinal photoreceptors, and in which red may appear dark. Deuteranopia is a color vision deficiency in which the green retinal photoreceptors are absent, moderately affecting red-green hue discrimination. Tritanopia is a very rare color vision disturbance in which there are only two cone pigments present and a total absence of blue retinal receptors.

Adjusting displays to account for different types of color blindness therefore may be difficult. Moreover, being able to do so at processing speeds which do not result in game play delays may increase the difficulty of doing so.

### BRIEF SUMMARY OF THE INVENTION

Aspects of the invention provide for real time modification of displays to account for color-vision deficiencies. In some aspects, the invention provides a computer implemented method for real-time color modification during video game play, comprising: transforming color values for a pixel from a first color space to an LMS color space; determining differences between the color values for the pixel in the LMS color space and color values of a simulated pixel in the LMS color space, the simulated pixel having color values simulating a color-vision deficiency view of the pixel; distributing at least a portion of the differences from a color value for a color associated with the color-vision deficiency to a color value of another color; adding a scaled version of the distributed differences to the color values for the pixel in the LMS color space; transforming the resulting color values for the pixel in the LMS color space to color values for a display color space; and providing the color values for the display color space to a display device.

In some aspects, the invention provides a machine readable non-transitory media for a video game, the machine readable media including program instructions for execution by at least one processor, the program instructions including program instructions for: determining video game states during play of a video game based in part on user inputs; rendering display information representative of at least some of the video game states, including determining display pixel values in a first color space; transforming the display pixel values to pixel values in an LMS color space; effectively performing operations using constant matrices on the pixel values in the LMS color space so as to modify the pixel values in the LMS color space, the constant matrices including a matrix representative of a transform atrix to transform a vector representative of pixel values in the LMS color space to a vector representative of pixel values of a color-deficiency view of a displayed pixel in the LMS color space and a matrix representative of a constant error distribution matrix; and transforming the pixel values in the LMS color space to pixel values in a display color space.

In some aspects, the invention provides a method for real-time modification of pixel, comprising: receiving a pixel to be displayed in video game scene; converting the pixel to LMS color space; determining an error between a normal vision response and a color blind vision response for the pixel; producing a modified pixel, production of the modified pixel including distributing at least some of the error from pixel components seen by defective cones to pixel components seen by normal cones; and converting the modified pixel to red green blue (RGB) color space.

These and other aspects of the invention are more fully comprehended upon review of this disclosure.

### BRIEF DESCRIPTION OF THE FIGURES

FIG. 1 is a block diagram of a system in accordance with aspects of the invention.

FIG. 2 is a block diagram of a video game console in accordance with aspects of the invention.

FIG. 3 is a flow diagram of a process for performing real-time color modification during video game play in accordance with aspects of the invention.

FIG. 4 is a flow diagram of a process for performing color modification in accordance with aspects of the invention.

FIG. 5 is a flow diagram of a process for performing chrominance real-time modification in accordance with aspects of the invention.

FIG. 6 is a flow diagram of a further process for performing chrominance modification in accordance with aspects of the invention.

FIG. 7 is a flow diagram of a process for performing luminance modification in accordance with aspects of the invention.

FIG. 8 is a simplified screenshot of a video game display.

FIG. 9 is a representation of a color blind view of the simplified screenshot of FIG. 8.

### DETAILED DESCRIPTION

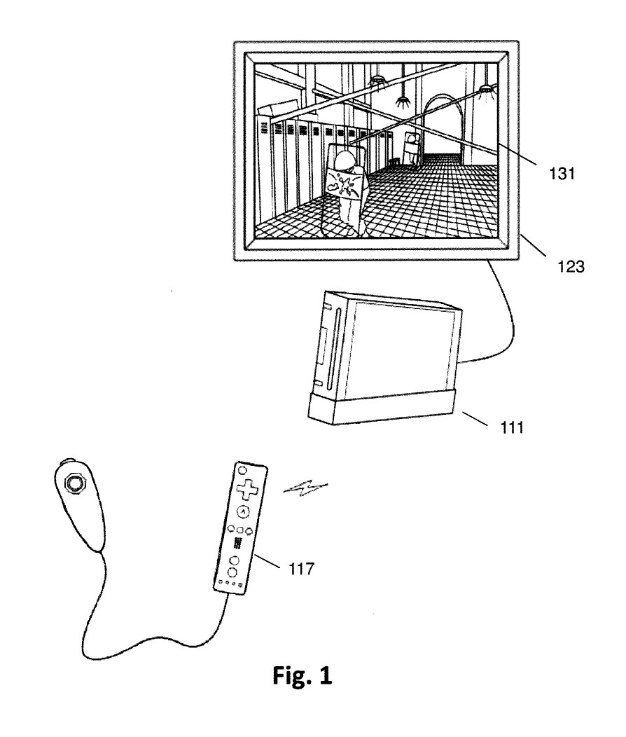

FIG. 1 illustrates an example of a video game system for play of a video game. In various embodiments, the video game may be an action game, for example a fighting game of a first-person shooter game, a role playing game, or a vehicle simulator game, or some other game. The video game system includes a game console 111 with at least one processor for executing program instructions providing for game play and associated circuitry, user input devices such as a game controller 117, and a display device 123 having a display screen 131. The processor, responsive to inputs from the user input devices, executes program instructions to provide for game play of the video game, generally including commanding display of game characters in and interacting with a virtual world of game play and possibly each other.

In the embodiment of FIG. 1, the display device shows a screen shot of video game play. The screen shot shown in FIG. 1 and other screen shots, generally show displays commanded to be displayed by the processor. In such embodiments the commands by the processor are typically not at the pixel level, but instead higher level commands are issued, with actual pixel level display information determined by a graphics processor of the game console. In determining the pixel values the graphics processor renders a particular scene, determining pixel values for the display, in accordance with the higher level commands. In various embodiments the graphics processor normally outputs what may be considered standard pixel color values, namely pixel values intended to provide a desired display for a non-color blind game player.

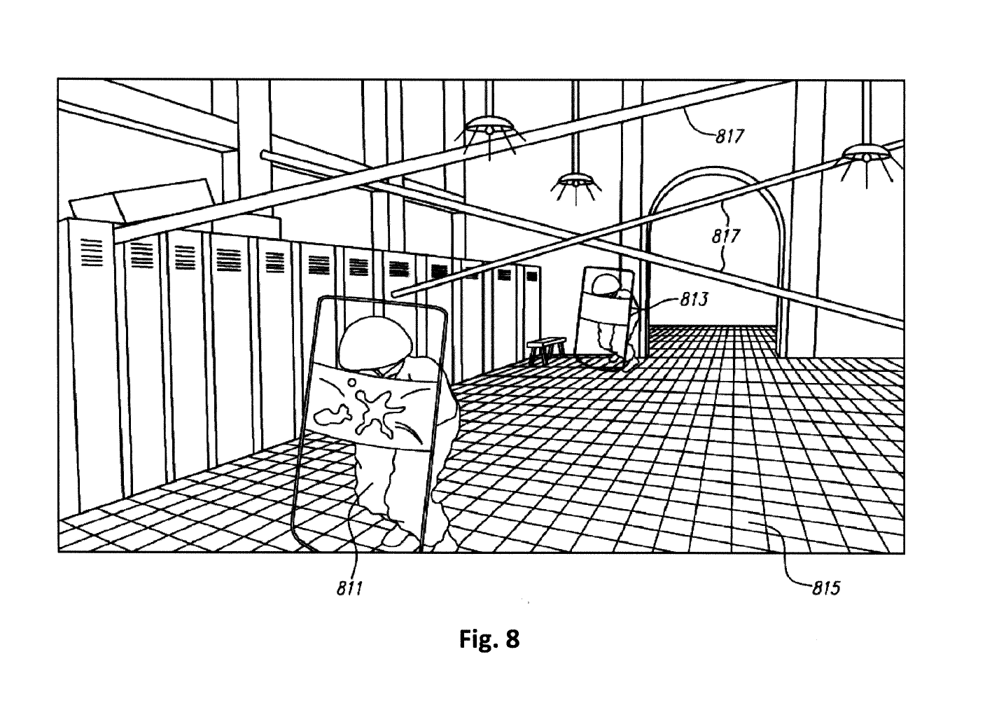

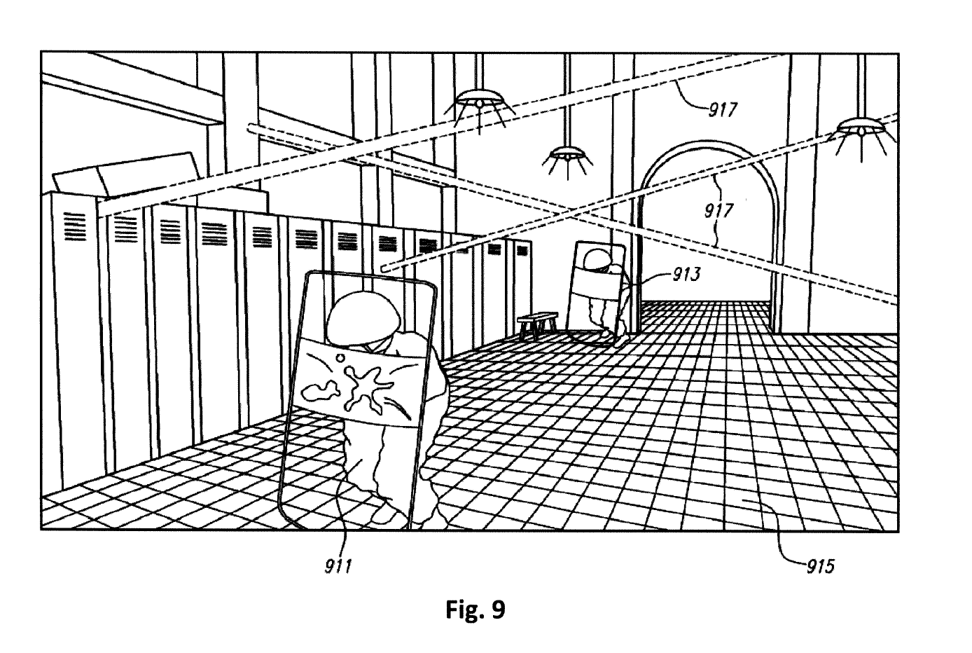

An example screenshot of such a display may be seen in FIG. 8. In FIG. 8 a first man 811 and a second man 813 are moving across a floor 815 of a locker room. A plurality of laser beams 817 cross the room in a diagonal manner. A purpose of a game player playing the game may be to have a game character cross the room while evading the men and avoiding contact with the laser beams. Unfortunately, a game player with a color-vision deficiency may not be able to fully or easily discern the elements of the display of FIG. 8. Instead, for example, such a game player may instead see a representation of the screen shot of FIG. 9. In FIG. 9, a first man 911 and a second man 913 are visible moving across a floor 915 of a locker room, as in FIG. 8. However, laser beams 917, outlined in dashed lines, may be only partially visible or not visible at all to the game player with a color-vision deficiency. A game player with the color-vision deficiency, therefore, may not be aware that the laser beams are present, with resulting possibly negative consequences for game play.

Accordingly, the graphics processor may adjust pixel colors to improve viewability by those with color-vision deficiency. In some embodiments the graphics processor may transform, using matrix operations, the standard pixel values, which may be in terms of RGB values, to an LMS (long, medium, short wavelength) color space, perform further matrix operations on the LMS pixel values to modify the LMS pixel values account for one or, in some embodiments, any one of several types of color blindness, and transform the modified LMS pixel values back to RGB pixel values for display.

In some embodiments the further matrix operations include, for each pixel, determining differences between the values for a pixel and a pixel simulating a color-vision deficient view of the pixel and distributing at least some of the differences from colors with an expected color-vision deficient response to colors without an expected color-vision deficient response. In some embodiments the pixel simulating the color-vision deficient view of the pixel is determined by effectively multiplying a vector representing values of the pixel with a constant matrix having values for transforming the vector to the color-vision deficient view of the pixel. In some embodiments the distribution of the differences is accomplished by effectively multiplying a vector representative of the differences by an error distribution matrix and adding the results, or scaled results, to the pixel. In some embodiments one or both of the matrices used in determining the pixel simulating the color-vision deficient view and the error distribution matrix are specified for a particular type or sub-type of color-vision deficiency, and in some embodiments one or both of the matrices are constant for the particular type or sub-type of color-vision deficiency.

The program instructions providing for game play are generally stored on removable media, for example, an optical disk, although in various embodiments the instruction providing for game play may instead be simply stored in other memory of the game console. Accordingly, the game console may include an optical drive, for example, a DVD-ROM drive, for reading the instructions for game play. In some embodiments, the game console may be replaced by a hand-held device suitable for video game play, such as a hand-held game device or smart phone, or by a personal computer, all of which may include similar internal circuitry as herein described, as well as, for example, a built-in display and built-in user input devices, such as a keyboard and a touch pad.

The display device is generally coupled to the game console by a cable, although in some embodiments a wireless connection may be used. In many embodiments, the display device is a liquid crystal display. In some embodiments, the display device is a television.

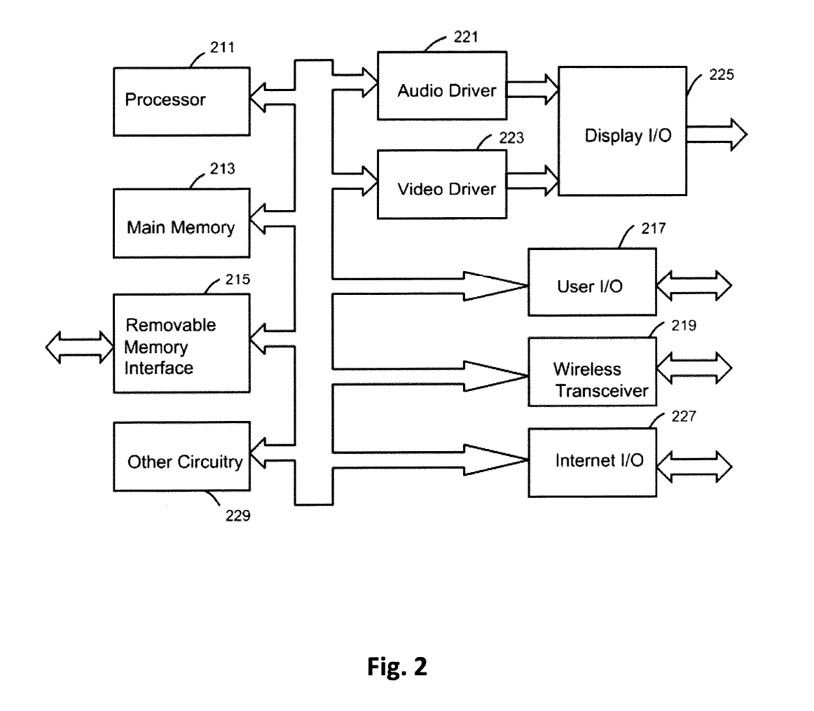

FIG. 2 is an example of a block diagram of a processor and associated circuitry, for example for a game console or other game capable device, useful in accordance with aspects of the invention. As shown in FIG. 2, a processor 211 is connected to other components via a bus. The other components include a main memory 213 and a removable memory interface 215 generally coupled to a removable memory device, for example, a DVD-ROM drive. The processor may execute instructions retrieved from the removable memory device to control game play and store game state information in the main memory. For example, the instructions may be for determining possible movements, positions, and locations of a game character.

The processor is coupled to an audio driver 221 and a video driver 223. The audio driver produces sound signals and the video driver produces image signals. The video driver may generally include a graphics processor, and in many embodiments the graphics processor and the processor may be coupled by their own bus, which in some embodiments may be comprised of point-to-point links. The sound signals and image signals are transmitted from the game console via a display I/O device 225. The display I/O device generally supplies the sound and image signals to a display device external to the game console. Sound signals may also be supplied to a peripheral device.

The processor may also be coupled to a user I/O device 217, a wireless transceiver 219, an Internet I/O device 227, and other circuitry 229. The user I/O device may receive signals from a keyboard, a mouse, and/or a game controller, with generally the keyboard, mouse, and/or controller or other input device being used by a user and providing user inputs, for example, during game play. Alternatively or additionally, the game console may receive user inputs via the wireless transceiver. The Internet I/O device provides a communication channel that may be used, for example, for multiple player games.

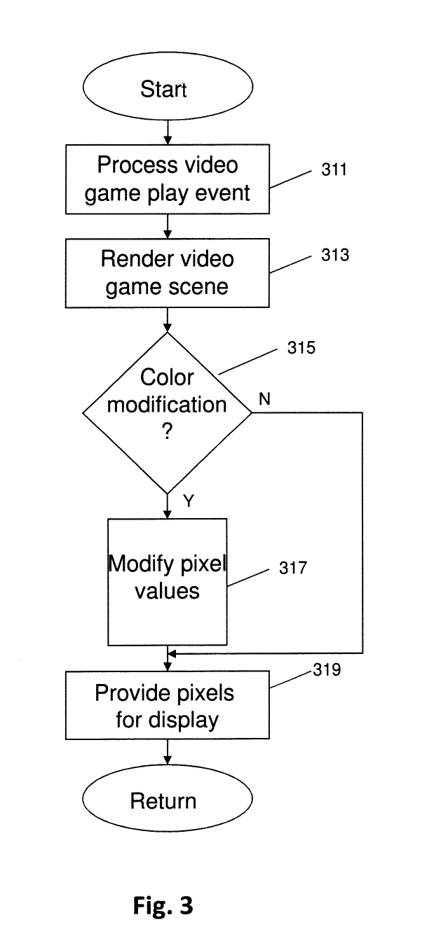

FIG. 3 is a flow diagram illustrating a process for real-time color modification during video game play in accordance with aspects of the present invention. For example, the process may be implemented by the video game console of FIG. 1 or the processor and associated circuitry of FIG. 2.

In block 311 the process processes a video game play event. The event may be a passage of time, a video game action based on a user input, for example indicative of a command to move a video game character or have the character manipulate an article, or some other video game event. Processing the event will generally include determining a new video game state, for example state of a video game character, including position and status.

In block 313, the process performs display processing of a video game scene, including rendering the video game scene. The process may be performed by the processor executing instructions to retrieve models which may be used to command drawing an object or objects for the video game scene, and a graphics processor determining pixel values, generally RGB pixel values.

In block 315, the process determines whether color modification is to be performed. In some embodiments, a player may selectively designate whether color modification is desired, for example prior to beginning play of a session of a video game or through a menu selection or a command during video game play. In such embodiments a flag may be set to indicate that color modification should be performed, and the process may check the status of the flag to determine whether color modification should be performed. The player may also, in some embodiments, designate a type of color modification to be performed. In some embodiments a type of color modification may be selected by the player, for example by way of a menu listing various types and/or sub-types of color-vision deficiencies. In some embodiments the process may implement a color blindness test to determine whether color modification should be performed. For example, the processor may execute instructions to test for color blindness by visually displaying images and prompting the player for responses. Based on the player responses to the visual cues, the processor may be used to determine whether color modification should be applied, and, if so, the type of modification, for example based on a type of color blindness that might apply to the player.

If no color modification is to be performed, the process continues to block 319.

On the other hand, when color modification is to be performed, the process continues to block 317. In some embodiments operations of block 317, if performed, are performed as each pixel, or groups of pixels, is generated during operation of block 313. In some embodiments operations of block 317, if performed, are performed after all pixels of a scene are generated during operations of block 313.

In block 317, the process modifies pixel values to account for color blindness. In various embodiments the process modifies the pixel values by effectively performing matrix operations on representations of the pixel values. In various embodiments the process converts the pixels from a Red Green Blue (RGB) color space to an LMS color space. The LMS color space may be useful for working with color blindness since the three kinds of cone cell responses to light (i.e., L, M, S) do not directly match the RGB color space.

In some embodiments an error between an expected normal vision cone response and an expected color blind cone response is used to determine a modified pixel. In some embodiments, the process may determine the error, which may be considered a difference between a normal vision expected response to the pixel and a color-vision deficient response to the pixel, distribute a portion of the error from colors with reduced visibility by those with the color-vision deficiency to colors without the reduction in visibility, such that the response is taken from defective cones and distributed to working cones of the game player. The modified pixel values are converted from the LMS color space to the RGB color space.

In some embodiments an error in luminance between an expected normal vision cone response to the modified pixel and an expected color blind cone response to the modified pixel is also used to modify luminance of the pixel, with the luminance error, or a portion thereof added to the pixel values. The luminance error, in some embodiments, may be added making use of an XYZ color space, with LMS color space values transformed to the XYZ color space, which provides for more convenient separation of and operations on pixel luminance values of a pixel, with pixel values afterwards transformed to the RGB color space.

In block 319 the process provides pixels to a display device for display of the video game scene.

The process thereafter returns.

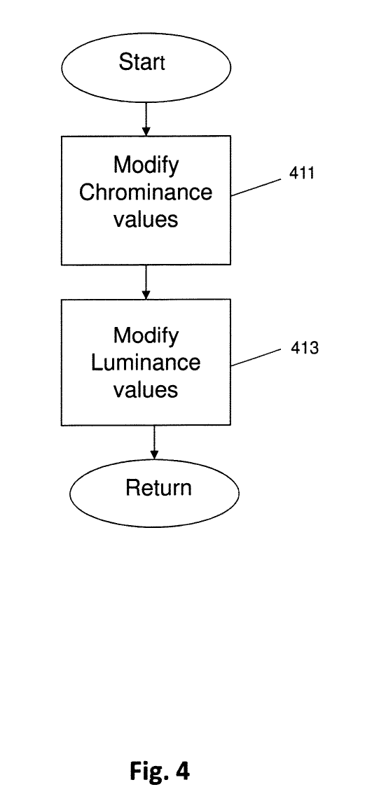

FIG. 4 is a flow diagram of a process for real-time color modification in accordance with aspects of the present invention. In some embodiments the process is performed by a device such as described with respect to FIG. 1, or a processor and associated circuitry of such a device, or processor and associated circuitry discussed with respect to FIG. 2. In some embodiments the process is performed by a graphics processor.

In block 411, the process modifies chrominance values for rendered pixels. In some embodiments the process receives pixels, P_{RGB}, expressed in an RGB color space. The pixels may be associated with film, video game, personal computing or other digital video display. Each pixel may be transformed to a corresponding pixel, P_{LMS}, in an LMS color space. The transformation may be made by effectively multiplying a 3×1 matrix representation of the pixel in the RGB color space by a 3×3 matrix representation of an RGB to LMS transformation matrix.

A modified LMS pixel value (Z) may be determined by performing operations on P_{LMS}. In some embodiments the modified pixel Z is determined by distributing an error between a normal vision response and a simulated color blind response to the LMS values of the LMS pixel value. In some embodiments a scalar is also applied to the distributed error.

The modified or chrominance shifted pixel may then be transformed to the RGB color space.

In optional block 413 the process modifies luminance values. For each pixel, a difference between luminance of Z, which may be considered a chrominance shifted pixel, and a pixel representing a color blind simulation of the chrominance shifted pixel is calculated. The difference in luminance may be determined by transforming the pixel value to an XYZ color space, where Y is luminance for the pixel, and determining a difference in the Y value of the pixel. The difference in Y, or a portion thereof, may be added to the Y value of the chrominance shifted pixel in the XYZ color space. In some embodiments the chrominance shifted pixel value in the RGB color space is transformed to the XYZ color space. In other embodiments the chrominance shifted pixel is not necessarily transformed from the LMS color space to the RGB color space, and instead the modified pixel in LMS color space is transformed to the XYZ color space, without for example undergoing the intermediate step of transformation to the RGB color space.

The process thereafter returns.

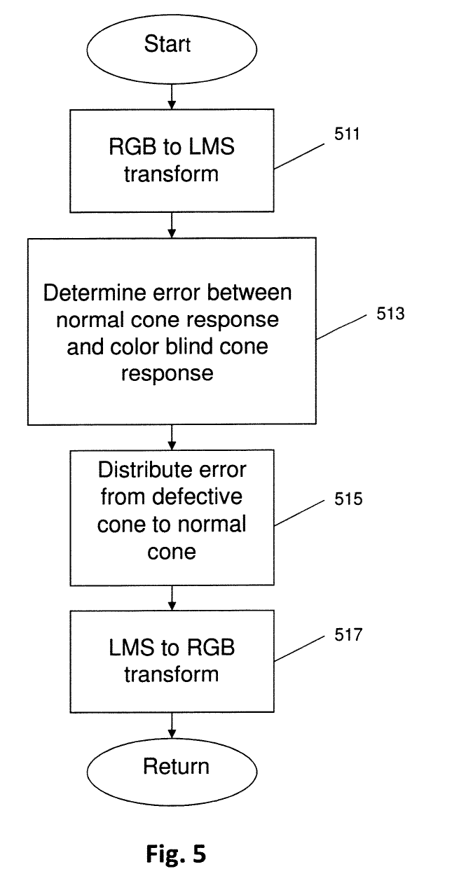

FIG. 5 is a flow diagram of a process for real-time color modification in accordance with aspects of the present invention. In some embodiments the process is performed by a device such as described with respect to FIG. 1, or a processor and associated circuitry of such a device, or processor and associated circuitry discussed with respect to FIG. 2. In some embodiments the process is performed by a graphics processor.

In block 511, an RGB to LMS color space transform is performed for a pixel. The conversion may be made by computing a linear transform as follows:

P_{LMS}=C_{RGBtoLMS}P_{RGB},

where C_{RGBtoLMS} is a constant transform matrix to convert between an RGB color space and an LMS color space. In some embodiments, C_{RGBtoLMS} may be given by

$${C}_{RGBtoLMS} = \begin{matrix}17.8824 & 43.5161 & 4.11935 \\ 3.45565 & 27.1554 & 3.86714 \\ 0.0299566 & 0.184309 & 1.46709\end{matrix}$$

In block 513, the process determines an error between normal cone response and a color blind cone response for the pixel in the LMS color space. In some embodiments the error may be computed as follows:

P_{ERROR}=P_{LMS}−TP_{LMS}, where T is a color blindness matrix for a particular ype of color blindness.

In some embodiments the type of color blindness may be protanopia, deuteranopia and tritanopia, Anomalous Trichromacy or other types of color blindness. The matrix T may be used to calculate a simulated color blind response. For example, in some embodiments, for protanopia, the color blindness matrix may be:

$${T}_{Protanope} = \begin{matrix}0.0 & 2.02344 & - 2.52581 \\ 0.0 & 1.0 & 0.0 \\ 0.0 & 0.0 & 1.0\end{matrix}$$

In some embodiments the color blindness type may be deutranopia and the color blindness matrix may be, for example:

$${T}_{Deuteranope} = \begin{matrix}1.0 & 0.0 & 0.0 \\ 0.49427 & 0.0 & 1.24827 \\ 0.0 & 0.0 & 1.0\end{matrix}$$

In some embodiments the color blindness type may be tritanopia, and the color blindness matrix may be:

$${T}_{Tritanope} = \begin{matrix}1.0 & 0.0 & 0.0 \\ 0.0 & 1.0 & 0.0 \\ - 0.395913 & 0.81109 & 0.0\end{matrix}$$

In block 515, the process distributes at least portions the error from colors associated with defective cones to colors associated with normal cones. In some embodiments, the error distribution may be expressed as:

P_{ERROR DIST}=φEP_{ERROR}, where φ is a scalar, which adjusts the strength of the chrominance shift, an E is an error distribution matrix.

The error distribution matrix E, may be used to distribute error from a defective cone to a normal cone. For example, for a protanopia type of color blindness, the error distribution matrix E may be specified as:

$$E = \begin{matrix}- 0.2 & 0.0 & 0.0 \\ 0.1 & 1.0 & 0.0 \\ 0.1 & 0.0 & 1.0\end{matrix}$$

In this example, the error distribution matrix E is provided to take 20% of the error from the L cone response, and apply 10% of the error to the M cone response and 10% of the error to the S cone response. In various embodiments the error distribution matrix may include other values to take other percentages of the error from colors associated with a cone and distribute the error to colors associated with other cones. In addition, the sample example error distribution matrix shows a distribution from a color associated with a particular cone to colors associated with other cones, and depending on the type of color blindness addressed the distribution may be from a color or colors associated with another cone or other particular cones. Further, in some embodiments the total percentage taken is equal to the total percentage applied, which may be beneficial in reducing changes in luminance of the output image.

The scalar φ may serve as a tuning parameter and may be in the range of 0 to 1, with larger values providing greater adjustment to a normal vision view. As such, the chrominance Shifting may be adjusted to accommodate varying degrees of color blindness. In some embodiments the scalar may be set to a constant, for example 0.20 or 0.50. In other embodiments the value scalar may be user selectable for example by way of a slider display allowing the user to set the scalar to values between 0 and 1.0 or 0.1 to 0.9.

In block 517, the process performs a LMS color space to the RGB color space transform for the resulting pixel. In some embodiments the pixel values may be converted from LMS color space to the RGB color space as follows:

P_{RGB}=C_{LMStoRGB}Z where C_{LMStoRGB} is a constant transform matrix to convert from LMS color space to RGB color space. In some embodiments, the constant transform matrix C_{LMStoRGB} may be given by:

$${C}_{LMStoRGB} = \begin{matrix}0.080944 & - 0.130504 & 0.11672 \\ - 0.01025 & 0.054019 & - 0.11362 \\ - 0.00037 & - 0.004122 & 0.69351\end{matrix}$$

In some embodiments, the modified pixel may be provided to a display device for display.

Thereafter, the process returns.

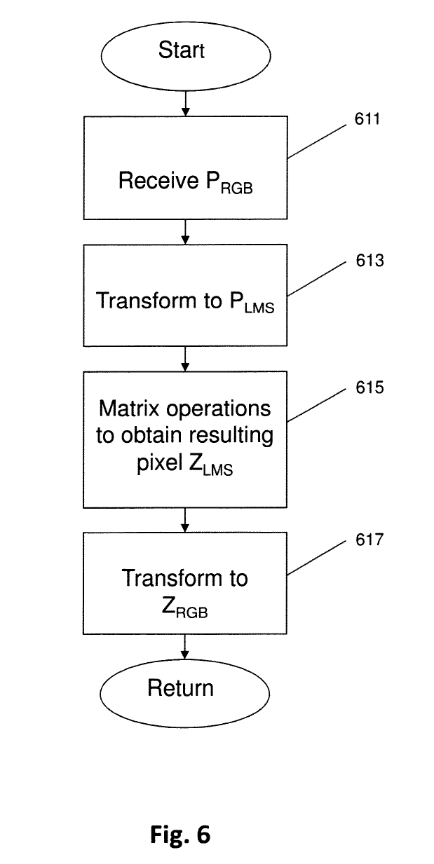

FIG. 6 is a flow diagram of a further process for determining a chrominance error in accordance with aspects of the present invention. In some embodiments the process is performed by a device such as described with respect to FIG. 1, or a processor and associated circuitry of such a device, or processor and associated circuitry discussed with respect to FIG. 2. In some embodiments the process is performed by a graphics processor.

In block 611, the process receives a pixel value P_{RGB} in the RGB color space. The pixel may be retrieved from memory or received in a video data stream and may be associated with film, a video game display sequence, a personal computing display or other digital video display.

In block 613, the process transforms the pixel P_{RGB} to the LMS color space. In some embodiments the conversion may be made by computing the linear transform as follows:

P_{LMS}=C_{RGBtoLMS}P_{RGB},

where C_{RGBtoLMS} is a constant transform matrix to convert between RGB and LMS color space. In some embodiments, C_{RGBtoLMS} may be as discussed with respect to FIG. 5.

In block 615, the process performs matrix operations to obtain a resulting pixel Z_{LMS}. In some embodiments, the resulting pixel is given by the formula:

Z_{LMS}=φE(P_{LMS}−TP_{LMS})+P_{LMS},

where φ is a scalar, which adjusts the strength of the chrominance shift, E is an error distribution matrix (for example an error distribution matrix as discussed with respect to FIG. 5), T is a color blindness matrix for the type of color blindness being addressed, and (P_{LMS}−TP_{LMS}) is a vector representing differences between the pixel and a simulated color blind response to the pixel in the LMS color space.

The type of color blindness may be, for example, protanopia, deuteranopia, tritanopia. Anomalous Trichromacy or other types of color blindness. The matrix T may be used to calculate a simulated color blind response. For example, in some embodiments, for protanopia, deuteranopia, and tritanopia the color blindness matrices may be, respectively, as discussed with respect to FIG. 5.

The scalar φ may serve as a tuning parameter and may be in the range of 0 to 1, with larger values providing greater adjustment to a normal vision view. As such, the chrominance shifting provided by the matrix operations may be adjusted to accommodate varying degrees of color blindness.

The process performs matrix multiplication of the error matrix and the difference vector, to distribute a portion of the error to the normal vision response such that the response is taken from the defective cones and distributed to the functioning cones. The process also applies the scalar, either to the error matrix or the result of the matrix multiplication, to produce a chrominance shift value. The chrominance shift is then added to the normal vision response to produce resulting pixel values.

In block 617, the process coverts the resulting pixel values to an RGB color space pixel Z_{RGB}. The resulting pixel values may be converted from LMS color space to the RGB color space as follows:

Z_{RGB}=C_{LMStoRGB}Z_{LMS}, where C_{LMStoRGB} is a constant transform matrix to convert from the LMS color space to the RGB color space, for example as discussed with respect to FIG. 5.

In some embodiments, the resulting pixel Z_{RGB} may be provided to the display device for display.

Thereafter, the process returns.

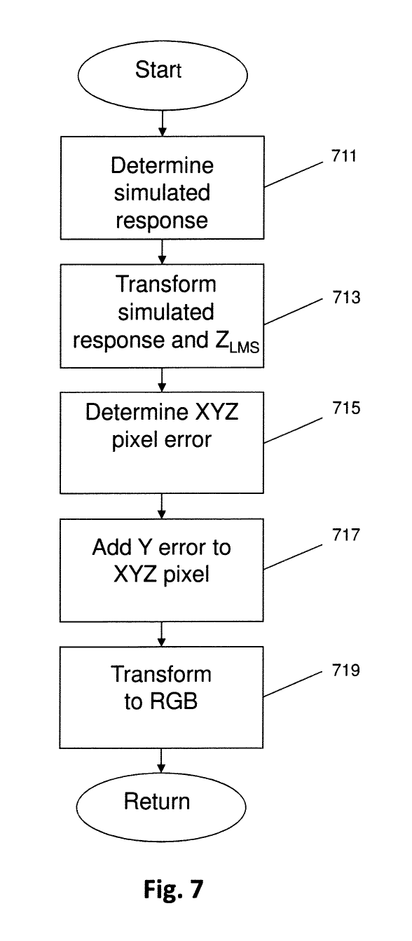

FIG. 7 is a flow diagram of a process for determining a luminance modification in accordance with aspects of the present invention. In some embodiments the process is performed by a device such as described with respect to FIG. 1, or a processor and associated circuitry of such a device, or processor and associated circuitry discussed with respect to FIG. 2. In some embodiments the process is performed by a graphics processor.

In block 711, the process determines a simulated response of a color-vision deficient individual to a chrominance shifted pixel (Z_{LMS}), for example the pixel Z_{LMS} as discussed with respect to FIG. 6. The luminance for the simulated color blind response may be given by

S_{z}=TZ, where T is a color blindness transform matrix for a specific type or sub-type of color blindness.

In block 713, the process transforms the simulated response S_{z} and Z_{LMS} to an XYZ color space. The use of the XYZ color space, with the Y component specifying luminance, is convenient in determining and modifying luminance values. Other color spaces which conveniently separate a luminance component of a pixel may be used in other embodiments. Although not as convenient for some purposes, in some embodiments color spaces which do not separate luminance components may also be used.

For example, for the chrominance shifted pixel the transform may be written as P_{XYZ}=C_{LMStoXYZ}Z_{LMS}, where C_{LMStoXYZ} is a constant transform matrix to convert from the LMS to the XYZ color space and Z_{LMS} is the modified or chrominance shifted pixel in the LMS color space. Similarly, the transform for the simulated color blind response may be given by P_{S}_{_{—}}_{XYZ}=C_{LMStoXYZ}S_{Z}. In some embodiments C_{LMStoXYZ} may be given by:

$${C}_{LMStoXYZ} = \begin{matrix}0.9870 & - 0.1471 & 0.1600 \\ 0.4323 & 0.5184 & 0.0793 \\ - 0.0085 & 0.0400 & 0.9685\end{matrix}$$

In block 715, the process determines a difference, or error, in luminance between the two pixels in the XYZ color space. The luminance error may be given by:

Lₑᵣᵣₒᵣ=P^{Y}_{xyz}−P^{Y}_{S}_{_{—}}_{XYZ}, with the superscript indicating the Y or luminance component.

In block 717, the process adds luminance Y error to the XYZ chrominance shifted pixel P_{XYZ}. The modified luminance value may be computed as follows:

P_{Xyz}+=ΦL_{Error}, where Φ is an effect scalar value having a range of 0 to 1 which may be used to adjust for clipping artifacts. For example, in especially bright images, larger values of Φ may result in more clipping artifacts being introduced in the resulting image. In some embodiments, the luminance error may be added directly without an effect scalar, or may be added in an amount varying in proportion based on proximity of a pixel to a maximum luminance value.

In block 719, the process transforms the luminance modified pixel to the RGB color space. The luminance modified pixel in XYZ color space may be converted to RGB color space as follows:

P_{RGB}=C_{XYZtoRGB}P_{XYZ}, where C_{XYZtoRGB} is a constant transform matrix to convert from XYZ to RGB color space. In some embodiments C_{XYZtoRGB} may be given by:

$${C}_{XYZtoRGB} = \begin{matrix}2.370674 & - 0.900041 & - 0.470634 \\ - 0.513885 & 1.425304 & 0.0888581 \\ 0.005298 & - 0.014695 & 1.009397\end{matrix}$$

The pixel may thereafter be provided to a display device for display.

Thereafter, the process returns.

Aspects of the invention relate to modification of pixel color values, for example to account for color-vision deficiencies. Although the invention has been discussed with respect to various embodiments, it should be recognized that the invention comprises the novel and non-obvious claims supported by this disclosure.

What is claimed is:

1. A computer implemented method for real-time color modification during video game play, comprising:
transforming color values for a pixel from a first color space to an LMS color space;
determining differences between the color values for the pixel in the LMS color space and color values of a simulated pixel in the LMS color space, the simulated pixel having color values simulating a color-vision deficiency view of the pixel;
distributing at least a portion of the differences from a color value for a color associated with the color-vision deficiency to a color value of another color;
adding a scaled version of the distributed differences to the color values for the pixel in the LMS color space;
transforming the resulting color values for the pixel in the LMS color space to color values for a display color space; and
providing the color values for the display color space to a display device.

2. The method of claim 1, wherein the display color space is an RGB color space.

3. The method of claim 2, wherein the first color space is an RGB color space.

4. The method of claim 1, wherein the scaled version of the distributed differences is the distributed differences.

5. The method of claim 1, wherein the scaled version of the distributed differences is between 10% and 100%, inclusive, of the distributed differences.

6. The method of claim 1, wherein determining differences between the color values for the pixel in the LMS color space and color values of the simulated pixel in the LMS color space comprises subtracting color values of the simulated pixel in the LMS color space from the color values for the pixel in the LMS color space.

7. The method of claim 6, wherein the color values of the simulated pixel in the LMS color space comprise a matrix representative of a linear transform, with a matrix representative of the color vision deficiency, of color values for the pixel in the LMS color space.

8. The method of claim 1 wherein distributing at least the portion of the differences from the color value for the color associated with the color-vision deficiency to the color value of another color comprises multiplication of an error distribution matrix with a vector representative of the differences.

9. The method of claim 1 wherein the scaled version of the distributed differences comprises the result of multiplication of a scalar with a vector representative of the distributed differences.

10. The method of claim 9 wherein a value of the scalar is based on a user input.

11. Machine readable non-transitory media for a video game, the machine readable media including program instructions for execution by at least one processor, the program instructions including program instructions for:
determining video game states during play of a video game based in part on user inputs;
rendering display information representative of at least some of the video game states, including determining display pixel values in a first color space;
transforming the display pixel values to pixel values in an LMS color space;
effectively performing operations using constant matrices on the pixel values in the LMS color space so as to modify the pixel values in the LMS color space, the constant matrices including a matrix representative of a transform matrix to transform a vector representative of pixel values in the LMS color space to a vector representative of pixel values of a color-deficiency view of a displayed pixel in the LMS color space and a matrix representative of a constant error distribution matrix; and
transforming the pixel values in the LMS color space to pixel values in a display color space.

12. The machine readable non-transitory media of claim 11, wherein the program instructions for effectively performing operations using constant matrices on the pixel values in the LMS color space so as to modify the pixel values in the LMS color space include program instructions for effectively multiplying a vector representative of values for a pixel in the LMS color space by the matrix representative of a transform matrix to transform a vector representative of pixel values in the LMS color space to the vector representative of pixel values of a color-deficiency view of a displayed pixel in the LMS color space.

13. The machine readable non-transitory media of claim 12, wherein the program instructions for effectively performing operations using constant matrices on the pixel values in the LMS color space so as to modify the pixel values in the LMS color space include program instructions for determining a difference between values for the pixel in the LMS color space and values for the color-deficiency view of the pixel in the LMS color space.

14. The machine readable non-transitory media of claim 13, wherein the program instructions for effectively performing operations using constant matrices on the pixel values in the LMS color space so as to modify the pixel values in the LMS color space include program instructions for distributing at least some of the difference between values for the pixel in the LMS color space and values for the color-deficiency view of the pixel in the LMS color space in the values for the pixel in the LMS color space.

15. The machine readable non-transitory media of claim 14, wherein the program instructions for distributing at least some of the difference between values for the pixel in the LMS color space and values for the color-deficiency view of the pixel in the LMS color space in the values for the pixel in the LMS color space include program instructions for effectively multiplying a vector representative of the difference with the matrix representative of a constant error distribution matrix and adding a result of the effective multiplication to the pixel in the LMS color space.

16. A method for real-time modification of pixel, comprising:
receiving a pixel to be displayed in video game scene;
converting the pixel to LMS color space;
determining an error between a normal vision response and a color blind vision response for the pixel;
producing a modified pixel, production of the modified pixel including distributing at least some of the error from pixel components seen by defective cones to pixel components seen by normal cones; and
converting the modified pixel to red green blue (RGB) color space.

17. The method of claim 16, further including displaying the modified pixel on a display.

18. The method of claim 16, wherein the color blind vision response is simulated according to a particular type of color blindness.

19. The method of claim 16, wherein producing a modified pixel further comprises modifying a luminance of a pixel having at least some of the error distributed.
